(19) United States
(12) Patent Application Publication
(10) Pub. No.: US 2019/0118861 A1
(43) Pub. Date: Apr. 25, 2019

(54) Motor Vehicle Steering Assembly

(71) Applicant: TRW Automotive GmbH, Alfdorf (DE)

(72) Inventors: Stefan Jaekel, Duesseldorf (DE); Robert Engler, Duesseldorf (DE)

(73) Assignee: TRW Automotive GmbH, Alfdorf (DE)

(21) Appl. No.: 16/096,748

(22) PCT Filed: Apr. 19, 2017
(86) PCT No.: PCT/EP17/59306

§ 371 Date: Oct. 26, 2018

(30) Foreign Application Priority Data
Apr. 28, 2016 (DE) 10 2016 107 916.2

(51) Int. Cl. B62D 15/02; B62D 6/10; G01L 3/10; G01L 5/22

(52) U.S. Cl. CPC B62D 15/0215; G01L 5/221; G01L 3/104; B62D 6/10

(57) ABSTRACT

A motor vehicle steering assembly having a steering shaft which extends from a vehicle steering wheel to a pinion and is rotatable about a steering axis, a combined steering angle and steering torque sensor which includes sensor elements connected to the steering shaft for joint rotation therewith, and a housing upper part of a multipart steering gear housing which closes, on the steering wheel side, a housing lower part for receiving the pinion, the housing lower part being open in the axial direction towards the vehicle steering wheel, the combined steering angle and steering torque sensor being received in the housing upper part, the steering shaft extending through the housing upper part, and the sensor elements connected to the steering shaft for joint rotation therewith being directly adjacent to the housing upper part.

### CROSS-REFERENCE TO RELATED APPLICATIONS

This application is a national stage of International Application No. PCT/EP2017/059306, filed 19 Apr. 2017, the disclosures of which are incorporated herein by reference in entirety, and which claimed priority to German Patent Application No. 10 2016 107 916.2, filed 28 Apr. 2016, the disclosures of which are incorporated herein by reference in entirety.

### BACKGROUND TO THE INVENTION

The invention relates to a motor vehicle steering assembly including a steering shaft which extends from a vehicle steering wheel to a pinion and is rotatable about a steering axis, a combined steering angle and steering torque sensor which includes sensor elements connected to the steering shaft for joint rotation therewith, a housing upper part of a multipart steering gear housing which closes, on the steering wheel side, a housing lower part for receiving the pinion, the housing lower part being open in the axial direction towards the steering wheel, the combined steering angle and steering torque sensor being received in the housing upper part, and the steering shaft extending through the housing upper part.

Motor vehicle steering assemblies of this type are already generally known from the prior art and are employed in rack-and-pinion steering systems in which both the steering angle and the manually applied steering torque are to be sensed by means of sensors. The sensors are usually mounted so as to float, in order to compensate for any radial and axial tolerances that are caused by the movement of the steering shaft.

Compared to sensors that exclusively sense the steering angle or exclusively sense the steering torque, combined steering angle and steering torque sensors require a larger installation space, so that they are difficult to integrate into the motor vehicle steering system because of the limited installation space available in the area of the steering shaft.

### SUMMARY OF THE INVENTION

It is therefore a feature of the invention to provide as compact a motor vehicle steering assembly as possible, which has a combined steering angle and steering torque sensor.

According to the invention, this feature is achieved by a motor vehicle steering assembly of the type initially mentioned in which the sensor elements connected to the steering shaft for joint rotation therewith are directly adjacent to the housing upper part of the multipart steering gear housing.

While conventional combined steering angle and steering torque sensors are manufactured as a prefabricated sensor unit having a separate sensor housing and are then built into the steering gear housing, according to the invention there is no provision made radially between the housing upper part of the steering gear housing and the rotatable sensor elements for a separate housing which encases the rotatable and stationary sensor elements and is connected to the steering gear housing so as to be locked against rotation in the radial direction after the sensor installation. However, the sensor elements directly adjacent to the housing upper part and firmly connected to the steering shaft may be spaced apart (for example by a radial air gap) from the housing upper part.

The function of the sensor housing is taken over by the housing upper part of the steering gear housing, so that a separate sensor housing may be dispensed with and the motor vehicle steering assembly may correspondingly have a more compact configuration.

The increased installation space required by the combined steering angle and steering torque sensor in comparison to a pure steering angle sensor or a pure steering torque sensor is more or less compensated for by the absence of the separate sensor housing, so that the use of the combined steering angle and steering torque sensor results in a reduction of installation space problems in the area of the steering shaft.

In one embodiment of the motor vehicle steering assembly, the steering shaft comprises an input shaft connected to the vehicle steering wheel, an output shaft connected to the pinion, and a torsion element which couples the input shaft and the output shaft in the circumferential direction. This allows the steering torque applied to the steering wheel to be determined in a simple manner from a rotation of the input shaft relative to the output shaft and from the torsional rigidity of the torsion element.

The combined steering angle and steering torque sensor preferably comprises a first sensor element having a connection to the input shaft for joint rotation therewith, and a second sensor element having a connection to the output shaft for joint rotation therewith, at least one of the connections for joint rotation being formed as an axial plug connection. Compared with currently employed welded connections, mounting a sensor element to the input shaft or the output shaft so as to prevent relative rotation can be realized significantly faster and easier by an axial plug connection.

Preferably, here the first sensor element or the input shaft includes an integrated or firmly preassembled form-fitting ring for forming the connection preventing relative rotation.

Further, it is preferred that the second sensor element or the output shaft includes an integrated or firmly preassembled form-fitting ring for forming the connection preventing relative rotation. In particular, in this context it is conceivable to use toothings engaging with each other in order to implement the axial plug connection for mounting a sensor element to the input shaft or the output shaft so as to prevent relative rotation.

Alternatively, at least one of the sensor elements may include radially elastic plug connection tongues, each engaging a tangentially flattened circumferential portion of the input shaft and/or of the output shaft to form the axial plug connection.

In one embodiment of the motor vehicle steering assembly, the housing upper part comprises a flange portion which surrounds the sensor elements firmly connected to the steering shaft and is connected to the housing lower part of the multipart steering gear housing.

Further, the housing upper part preferably comprises a bearing portion which includes a radial bearing for rotatably mounting the steering shaft and supporting transverse forces.

In particular, a sealing element for sealing between the housing upper part and the steering shaft may be arranged in this bearing portion. By encasing the combined steering angle and steering torque sensor, by providing a rotary support for the steering shaft, and by sealing the steering gear housing against the steering shaft, the housing upper part assumes a plurality of functions and thus contributes to a particularly compact design of the motor vehicle steering assembly.

According to one embodiment of the motor vehicle steering assembly, the flange portion and the bearing portion constitute separate components of the housing upper part.

In this embodiment it is preferred that the flange portion of the housing upper part surrounds the combined steering angle and steering torque sensor and is arranged axially between the bearing portion of the housing upper part and the housing lower part.

Furthermore, in this embodiment the combined steering angle and steering torque sensor may comprise a magnetic ring, a magnetic structural unit that can be rotated relative to the magnetic ring, and an electric sensor unit, the flange portion, the magnetic structural unit and the electric sensor unit constituting a preassembled subassembly. This subassembly can, for example, be purchased in a preassembled state from a supplier and then allows the motor vehicle steering assembly to be rapidly assembled.

According to an alternative embodiment of the motor vehicle steering assembly, the flange portion and the bearing portion of the housing upper part are formed in one piece. In this case, the number of individual components and therefore also the assembly effort for the motor vehicle steering assembly are reduced.

For example, in this embodiment of the motor vehicle steering assembly, the combined steering angle and steering torque sensor comprises a magnetic ring, a magnetic structural unit that can be rotated relative to the magnetic ring, and an electric sensor unit, the housing upper part, the magnetic structural unit and the electric sensor unit constituting a preassembled subassembly. This subassembly can, for example, be purchased in a preassembled state from a supplier and then allows the motor vehicle steering assembly to be rapidly assembled.

As an alternative, in this embodiment of the motor vehicle steering assembly, the housing upper part and the combined steering angle and steering torque sensor may also constitute a preassembled subassembly. This subassembly can, for example, be purchased in a preassembled state from a supplier and be checked for its correct sensor function even before it is installed in the motor vehicle steering assembly. Furthermore, this subassembly allows a particularly simple mounting of the motor vehicle steering assembly since it is merely fitted axially onto the steering shaft and then connected to the housing lower part of the multipart steering gear housing.

According to a further embodiment of the motor vehicle steering assembly, the combined steering angle and steering torque sensor comprises a magnetic ring, a magnetic structural unit, and an electric sensor unit, the magnetic structural unit including a gear rim arranged coaxially with the steering shaft and firmly connected to the steering shaft, and the electric sensor unit including at least one elastically supported gearwheel which is in meshing engagement with the gear rim. More particularly, the gearwheel of the electric sensor unit is elastically supported in the radial direction, so that a correct sensor function is ensured even if the steering shaft exhibits certain manufacturing tolerances, for example slight bending and/or a radial offset between the input shaft and the output shaft, or if an offset is caused by gimbal forces due to dynamic movement of the steering shaft relative to the steering gear housing.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a longitudinal section taken through a motor vehicle steering assembly according to an embodiment of the invention, in the installed state;

FIG. 2 shows a method of assembling the motor vehicle steering assembly according to FIG. 1;

FIG. 3 shows a simplified perspective exploded view of a combined steering angle and steering torque sensor of the motor vehicle steering assembly according to FIG. 1;

FIG. 4 shows a longitudinal section taken through a motor vehicle steering assembly according to a further embodiment of the invention, in the installed state;

FIG. 5 shows a longitudinal section taken through a motor vehicle steering assembly according to a further embodiment of the invention, in the installed state;

FIG. 6 shows the motor vehicle steering assembly according to FIG. 5, disassembled into subassemblies;

FIG. 7 shows a perspective view of the motor vehicle steering assembly according to FIG. 6 in the assembled state;

FIG. 8 shows a longitudinal section taken through a motor vehicle steering assembly according to a further embodiment of the invention, in the installed state;

FIG. 9 shows the motor vehicle steering assembly according to FIG. 8, disassembled into subassemblies;

FIG. 10 shows a perspective view of the motor vehicle steering assembly according to FIG. 9 in the assembled state;

FIG. 11 shows a longitudinal section taken through a motor vehicle steering assembly according to a further embodiment of the invention, in the installed state;

FIG. 12 shows the motor vehicle steering assembly according to FIG. 11, disassembled into subassemblies;

FIG. 13 shows a perspective view of the motor vehicle steering assembly according to FIG. 12 in the assembled state;

FIG. 14 shows a rotary entrainment between a magnetic ring and a magnetic structural unit of the motor vehicle steering assembly according to FIGS. 11 to 13;

FIG. 15 shows a detail view of the connection for joint rotation between the output shaft and a form-fitting ring attached to the second sensor element;

FIG. 16 shows a detail view of the connection illustrated in FIG. 15 according to an alternative variant embodiment;

FIG. 17 shows a detail view of the connection illustrated in FIG. 15 according to a further alternative variant embodiment;

FIG. 18 shows a detail view of the connection illustrated in FIG. 15 according to a further alternative variant embodiment;

FIG. 19 shows a detail view of the connection illustrated in FIG. 15 according to a further alternative variant embodiment;

FIG. 20 shows a detail view of the connection illustrated in FIG. 15 according to a further alternative variant embodiment;

FIG. 21 shows a detail view of the connection illustrated in FIG. 15 according to a further alternative variant embodiment; and

FIG. 22 shows a detail view of a form-fitting ring attached to the output shaft, for a connection for joint rotation with the second sensor element.

### DETAILED DESCRIPTION OF THE INVENTION

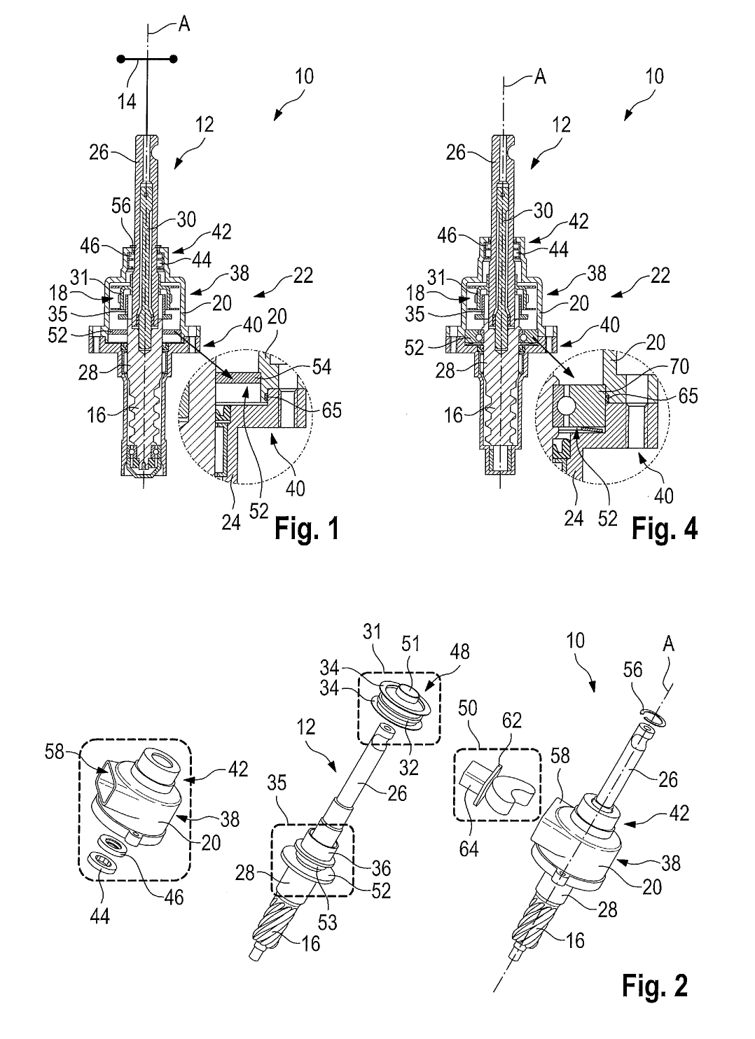

FIG. 1 shows an embodiment of a motor vehicle steering assembly 10 for a rack-and-pinion steering of a motor vehicle, including a steering shaft 12 which extends from a schematically indicated vehicle steering wheel 14 to a pinion 16 and is rotatable about a steering axis A, a combined steering angle and steering torque sensor 18 which includes sensor elements 31, 35 connected to the steering shaft 12 for joint rotation therewith, and a housing upper part 20 of a multipart steering gear housing 22, the combined steering angle and steering torque sensor 18 being received in the housing upper part 20.

According to FIG. 1, in addition to the housing upper part 20, the multipart steering gear housing 22, which is in the form of an external housing, comprises a housing lower part 24 for receiving the pinion 16, the housing lower part being open in the axial direction towards the vehicle steering wheel 14, the housing upper part 20 closing the housing lower part 24 on the steering wheel side.

The steering shaft 12 extends through the multipart steering gear housing 22, in particular also through the housing upper part 20, the steering shaft 12 protruding axially from the housing upper part 20 on the steering wheel side and being sealed against the housing upper part 20.

According to FIG. 1, the steering shaft 12 comprises an input shaft 26 connected to the vehicle steering wheel 14 for joint rotation therewith, an output shaft 28 connected to the pinion 16 for joint rotation therewith, and a torsion element 30 which is formed as a torsion bar and couples the input shaft 26 and the output shaft 28 in the circumferential direction. Further, the torsion bar is firmly connected to the input shaft 26 and the output shaft 28 in the axial direction, in particular crimped or press-fitted.

A rotation of the vehicle steering wheel 14, which is coupled so as to rotate jointly with the input shaft 26, is therefore transmitted to the output shaft 28 by means of the torsion element 30. The pinion 16 of the output shaft 28 meshes in a known manner with a rack of the motor vehicle steering, which in turn is coupled to steerable vehicle wheels and converts a rotation of the vehicle steering wheel 14 to a steering angle of the steerable vehicle wheels.

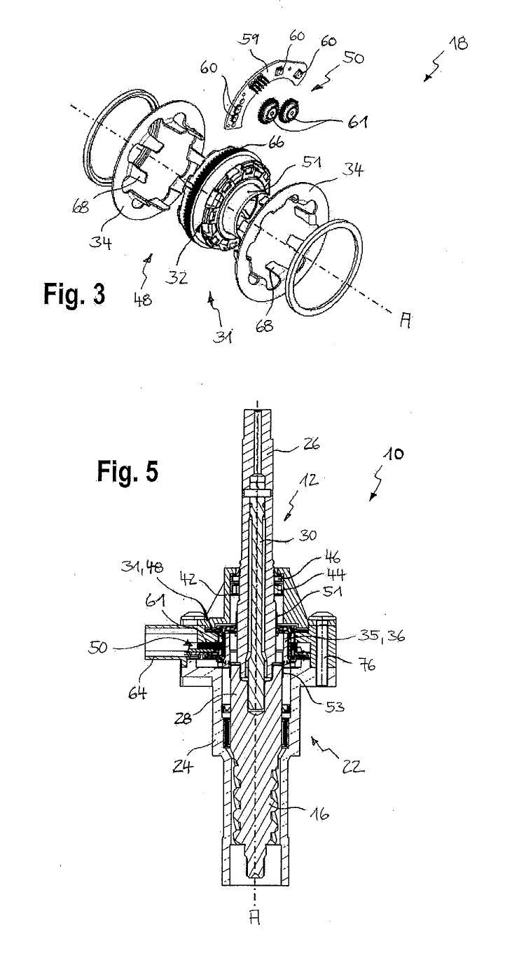

The combined steering angle and steering torque sensor 18 is provided to sense both a steering angle of the steering shaft 12 and a steering torque applied to the vehicle steering wheel 14. For this purpose, the combined steering angle and steering torque sensor 18 includes sensor elements connected to the steering shaft 12 for joint rotation therewith. In particular, a first sensor element 31 such as, for example, a gear rim 32 having magnetizable metal rings 34 (see also FIG. 3) is coupled to the input shaft 26 for joint rotation therewith, while a second sensor element 35 such as, for example, a magnetic ring 36 in the form of a magnet wheel is coupled to the output shaft 28 for joint rotation therewith (see FIG. 2).

The sensor elements 31, 35, which are connected to the steering shaft 12, specifically to the input shaft 26 or the output shaft 28, so as to rotate jointly therewith, are directly adjacent in the radial direction to a circumferential wall of the housing upper part 20, a radial air gap that extends in the circumferential direction being provided between the sensor elements 31, 35 and the housing upper part 20. The function of a sensor housing is therefore taken over by the housing upper part 20 of the steering gear housing 22, so that no separate intermediate housing is provided between the housing upper part 20 and the rotatable sensor elements 31, 35. The omission of such a separate intermediate housing results in a particularly compact motor vehicle steering assembly 10, since the installation space requirement is reduced in both the axial and the radial direction.

The housing upper part 20 comprises a flange portion 38 which surrounds the sensor elements 31, 35 firmly connected to the steering shaft 12 and is connected to the housing lower part 24, in particular to a flange portion 40 of the housing lower part 24. Further provided in the housing upper part 20, in particular in the flange portion 38 of the housing upper part 20, is a connecting duct 58 via which the combined steering angle and steering torque sensor 18 is connected to an electric control unit of the motor vehicle steering. In addition, an electric sensor unit 50 of the combined steering angle and steering torque sensor 18 may be inserted into the housing upper part 20 through the connecting duct 58 (see FIG. 2 on the right).

The housing upper part 20 further comprises a bearing portion 42 which includes a radial bearing 44 for rotatably mounting the steering shaft 12, the radial bearing 44 specifically forming a rotary bearing for the input shaft 26.

In addition, as shown in FIG. 1, a sealing element 46 is also arranged in the bearing portion 42 of the housing upper part 20 for sealing between the housing upper part 20 and the steering shaft 12 (specifically the input shaft 26).

In the embodiment of the motor vehicle steering assembly 10 according to FIG. 1, the flange portion 38 and the bearing portion 42 of the housing upper part 20 are formed in one piece. The housing upper part 20 is preferably made of a plastic material here, but alternatively it would also be conceivable to make it of metal.

At any rate, the housing upper part 20 has to be designed to be sufficiently stable in order to be able to absorb axial pull-off forces as well as radial forces of the input shaft 26 in the event of a breaking of the torsion element 30.

FIG. 2 illustrates a mounting method for the motor vehicle steering assembly 10 as shown in FIG. 1.

Here, first the housing upper part 20 is provided, which comprises the flange portion 38 and the bearing portion 42 formed in one piece with the flange portion 38. The sealing element 46 and the radial bearing 44 are then inserted into the housing upper part 20 and fastened to the housing upper part 20 in the area of the bearing portion 42, so that a preassembled subassembly is obtained.

In the illustrated embodiment of the motor vehicle steering assembly 10, the combined steering angle and steering torque sensor 18 comprises a magnetic structural unit 48 as the first sensor element 31 (see also FIG. 3), the magnetic ring 36 as the second sensor element 35 and, furthermore, an electric sensor unit 50 firmly connected to the housing upper part 20.

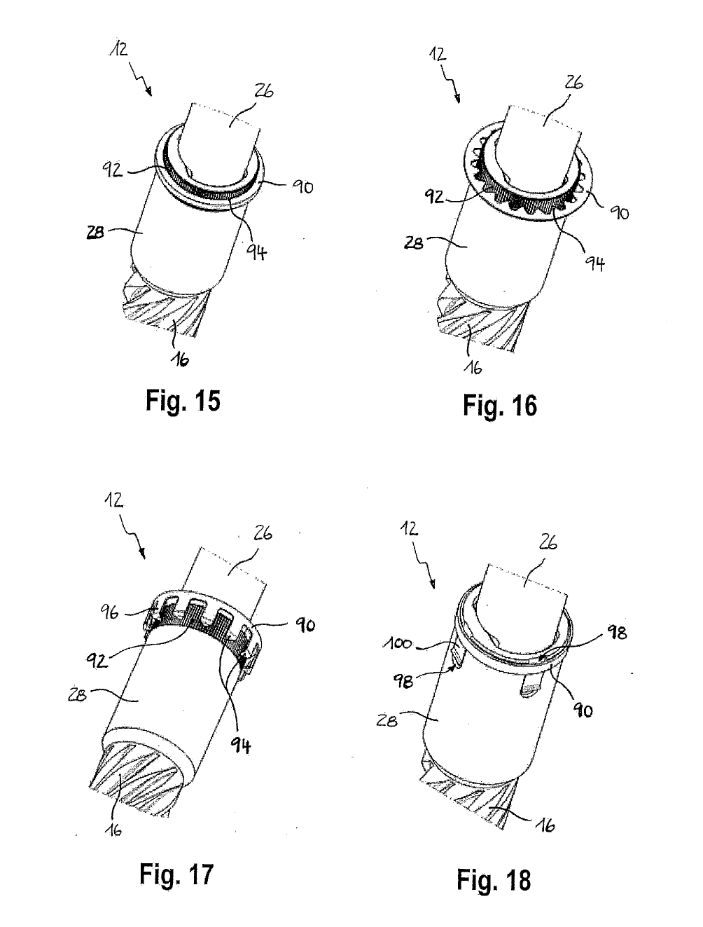

The magnetic structural unit 48 has an axial recess in the center for lead-through of the input shaft 26 and is fitted axially onto the input shaft 26 and connected to the input shaft 26 so as to prevent relative rotation. In the illustrated embodiment, the magnetic structural unit 48 includes an axially protruding metal sleeve 51 on the steering wheel side, which is welded to the input shaft 26 to attach the magnetic structural unit 48 to the steering shaft 12. As an alternative, the connection preventing relative rotation may also be achieved by a form-fitting connection when the magnetic structural unit 48 is axially fitted on, whereby the mounting effort for the motor vehicle steering assembly 10 is significantly reduced. A form-fitting connection established by the magnetic structural unit 48 being fitted on axially may be produced here by analogy with the variant embodiments shown in FIGS. 15 to 22.

The magnetic ring 36 is formed as a magnet wheel in a known manner and has a plurality of permanent magnets the poles of which are arranged alternately in the circumferential direction. The magnetic ring 36 likewise has a central axial recess for lead-through of the output shaft 28, is fitted onto the output shaft 28 and connected to it so as to prevent relative rotation. In the illustrated embodiment, the metal magnetic ring 36 includes a sleeve-shaped, axially protruding extension 53 on the pinion side, which is welded to the output shaft 28 to attach the magnetic ring 36 to the steering shaft 12. As an alternative, the connection preventing relative rotation may also be achieved by a form-fitting connection when the magnetic ring 36 is axially fitted on, as a result of which the mounting effort for the motor vehicle steering assembly 10 is significantly reduced. FIGS. 15 to 22 show feasible variants for embodying a form-fitting connection produced by the magnetic ring 36 being axially fitted on.

According to FIGS. 1 and 2, a transport guard element 52 is also provided, which closes the housing upper part 20, which is open on the pinion side, before the motor vehicle steering assembly 10 is mounted to the housing lower part 24. Together with the radial bearing 44, the transport guard element 52 prevents an undesirable oscillation of the input shaft 26 in the housing upper part 20, which could lead to damage to the combined steering angle and steering torque sensor 18.

In the embodiment according to FIG. 1, the transport guard element 52 is in the form of a plastic ring 54, which is put onto the output shaft 28 and, after mounting of the housing upper part 20, fixes the output shaft 28 in place radially centrally in the housing upper part 20 (see detail view in FIG. 1). The plastic ring 54 may only temporarily serve as a transport guard for the motor vehicle steering assembly 10 and may be removed again before the motor vehicle steering assembly 10 is mounted to the housing lower part 24 of the steering gear housing 22. Alternatively, however, it is also conceivable that the plastic ring 54 remains permanently in the steering gear housing 22.

After the magnetic structural unit 48 is mounted to the input shaft 26 so as to prevent relative rotation, the housing upper part 20 with the preassembled radial bearing 44 and sealing element 46 is pushed axially over the magnetic structural unit 48 from the end of the steering shaft 12 on the steering wheel side and fixed in place.

For axially fixing the housing upper part 20 to the steering shaft 12, a snap ring 56 is provided, for example, which, after the housing upper part 20 is mounted, is fitted axially onto the input shaft 26 and snaps in place in an input shaft groove, so that it prevents a movement of the housing upper part 20 relative to the steering shaft 12 axially toward the vehicle steering wheel 14.

In the next assembly step, the electric sensor unit 50 is inserted radially into the connecting duct 58 of the housing upper part 20 (see FIG. 2, on the right) until the electric sensor unit 50 has reached a desired final assembly position relative to the magnetic structural unit 48.

As an alternative, it is also conceivable that the electric sensor unit 50 is only mounted after the assembly of the other components of the motor vehicle steering assembly 10 and the installation thereof in a vehicle steering system.

The electric sensor unit 50 comprises, for example, a printed circuit board 59 with Hall sensors 60, small gearwheels 61 for steering angle measurement (see also FIG. 3), a closure element 62, which seals the connecting duct 58 essentially tightly, and a plug connector 64 for connecting the combined steering angle and steering torque sensor 18 to a power supply and an electric control unit of the vehicle steering system.

After the electric sensor unit 50 has been received in a sealed manner in the connecting duct 58 of the housing upper part 20, the magnetic ring 36 is aligned with the magnetic structural unit 48 in the circumferential direction and connected to the output shaft 28 so as to prevent relative rotation.

If a desired mounting position of the magnetic ring 36 in the circumferential direction can be determined already in advance, it is also conceivable, according to an alternative variant embodiment, to connect the magnetic ring 36 to the output shaft 28 for joint rotation already at the beginning of the mounting process, i.e. before mounting the magnetic structural unit 48 and the housing upper part 20.

The assembly of the motor vehicle steering assembly 10 is then completed by fitting the transport guard element 52 onto the output shaft 28. It is now possible, for example, to carry out a functional check of the combined steering angle and steering torque sensor 18 and a transportation to the other components of the rack-and-pinion steering in order to install the motor vehicle steering assembly 10. This installation can be realized quickly and simply by tightly attaching the housing upper part 20 to the housing lower part 24 of the multipart steering gear housing 22. Specifically, this attachment can be implemented, for example, as a clamping connection, snap connection or threaded connection, with a seal 65 being provided in particular for sealing between the housing upper part 20 and the housing lower part 24 (see, for example, FIG. 1).

FIG. 3 shows, in a simplified manner, the essential structure of the magnetic structural unit 48 and the electric sensor unit 50 of the combined steering angle and steering torque sensor 18.

It is apparent here that the magnetic structural unit 48 includes, as its principal components, the gear rim 32 which is produced from a plastic material, for example, and has an external toothing 66, and two magnetizable metal rings 34 having axially projecting metal tongues 68 engaging with each other.

A magnetic field is created between the metal rings 34 of the magnetic structural unit 48 and the magnetic ring 36, the magnetic field changing upon a relative rotation between the input shaft 26 and the output shaft 28.

This magnetic field change is detected in a known manner by Hall sensors 60 in the electric sensor unit 50 and passed on to an electric control unit. Based on this, along with the torsional rigidity of the torsion element 30, the electric control unit can determine, in a known manner, a steering torque applied to the vehicle steering wheel 14.

According to FIG. 3, the electric sensor unit 50 further has two gearwheels 61 which are in meshing engagement with the gear rim 32 of the magnetic structural unit 48. To allow any manufacturing tolerances of the steering shaft 12 to be compensated, such as, e.g., a certain bending or a radial offset between the input shaft 26 and the output shaft 28, the gearwheels 61 are mounted elastically with respect to the steering axis A, in particular in the radial direction. This simple compensation of manufacturing tolerances increases the functional reliability of the combined steering angle and steering torque sensor 18.

When the vehicle steering wheel 14 is rotated, the magnetic structural unit 48 connected to the input shaft 26 for joint rotation therewith and thus also the gear rim 32 are rotated. The gearwheels 61 of the electric sensor unit 50 mesh with an external toothing 66 of the gear rim 32 and are also rotated accordingly. Furthermore, the gearwheels 61 are coupled to dipoles so that one of the Hall sensors 60 of the electric sensor unit 50 can detect the rotation of the gearwheels 61 in a known manner and transmit respective data to the electric control unit of the vehicle steering system to determine the steering angle.

FIG. 4 shows the motor vehicle steering assembly 10 according to an alternative embodiment, which differs from the motor vehicle steering assembly 10 according to FIG. 1 merely in that the transport guard element 52 is formed as a bearing 70, rather than as a plastic ring 54.

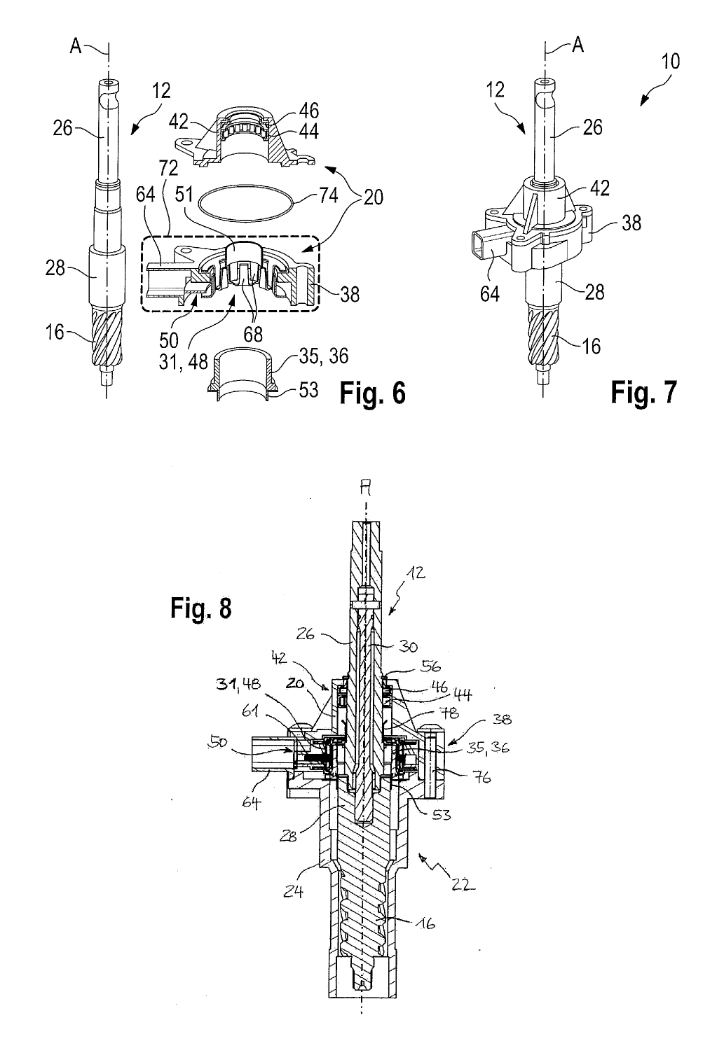

FIGS. 5 to 7 show the motor vehicle steering assembly 10 according to a further embodiment.

The general design structure and the operating principle of the combined steering angle and steering torque sensor 18 remain essentially unchanged as compared to the embodiment described with reference to FIGS. 1 to 3, so that in this respect, reference is made to the above description, and primarily the differences will be discussed below.

The motor vehicle steering assembly 10 according to FIGS. 5 to 7 mainly differs from the embodiment according to FIGS. 1 to 5 in that the flange portion 38 and the bearing portion 42 of the housing upper part 20 are no longer configured in one piece, but constitute separate components of the housing upper part 20.

Here, the flange portion 38 of the housing upper part 20 surrounds the combined steering angle and steering torque sensor 18 and is arranged axially between the bearing portion 42 of the housing upper part 20 and the housing lower part 24 of the steering gear housing 22.

By analogy with the embodiment according to FIGS. 1 to 3, the combined steering angle and steering torque sensor 18 comprises the magnetic ring 36, the magnetic structural unit 48 which is rotatable relative to the magnetic ring 36, and the housing-fixed electric sensor unit 50; in the embodiment according to FIGS. 5 to 7, the flange portion 38, the magnetic structural unit 48 and the electric sensor unit 50 constitute a preassembled subassembly 72.

The flange portion 38 here encases substantially the entire magnetic structural unit 48 in the axial direction. Only the metal sleeve 51 of the magnetic structural unit 48 protrudes axially slightly beyond the flange portion 38 to allow the magnetic structural unit 48 to be simply welded to the input shaft 26.

When assembling the motor vehicle steering assembly 10 according to FIGS. 5 to 7, first the preassembled subassembly 72 consisting of the flange portion 38, the magnetic structural unit 48 and the electric sensor unit 50 is pushed onto the input shaft 26 and firmly connected to, in particular welded to, the input shaft 26. Then a seal 74 and the bearing portion 42 with the preassembled radial bearing 44 and the preassembled sealing element 46 are pushed axially onto the input shaft 26 in order to sealingly close the flange portion 38 on the steering wheel side.

In the final step of assembling the motor vehicle steering assembly 10, the magnetic ring 36 is adjusted on the output shaft in the circumferential direction and is firmly connected to the output shaft 28. In particular, by analogy with the embodiment according to FIGS. 1 to 3, the magnetic ring 36 is welded to the output shaft 28 by means of its axial sleeve-shaped extension 53.

FIG. 5 shows a longitudinal section through the motor vehicle steering assembly 10 already installed in the rack-and-pinion steering, with the flange portion 38 of the housing upper part 20, the bearing portion 42 of the housing upper part 20, and the flange portion 40 of the housing lower part 24 being connected to each other by bolts 76.

Instead of the bolted connection, alternative fastening options which allow a tight connection of the individual components of the multipart steering gear housing 22 are, of course, also conceivable.

FIGS. 8 to 10 show the motor vehicle steering assembly 10 according to a further embodiment.

The motor vehicle steering assembly 10 according to FIGS. 8 to 10 differs from the embodiment according to FIGS. 5 to 7 merely in that the flange portion 38 and the bearing portion 42 of the housing upper part 20 are formed in one piece.

In this embodiment too, the combined steering angle and steering torque sensor 18 comprises the magnetic ring 36, the magnetic structural unit 48 which is rotatable relative to the magnetic ring 36, and the housing-fixed electric sensor unit 50, with the one-piece housing upper part 20, the magnetic structural unit 48 and the electric sensor unit 50 constituting a preassembled subassembly 77.

As a result of the housing upper part 20 being made in one piece, welding of the magnetic structural unit 48 to the input shaft 26 is no longer possible in this case. Therefore, the connection preventing relative rotation between the input shaft 26 and the magnetic structural unit 48 is in this case configured as an axial plug connection. To this end, radially elastic plug connection tongues 78 are provided on the first sensor element 31 of the magnetic structural unit 48, which each engage a tangentially flattened circumferential portion 80 of the input shaft 26 to form the axial plug connection.

The connection preventing relative rotation between the input shaft 26 and the magnetic structural unit 48 is therefore achieved by clamping.

In order to provide a stronger connection preventing relative rotation, it is also conceivable as an alternative to use the axial plug connection to produce a form-fitting engagement, for example by toothings engaging with each other. Such a plug connection may be formed analogously with the variant embodiments shown in FIGS. 15 to 22.

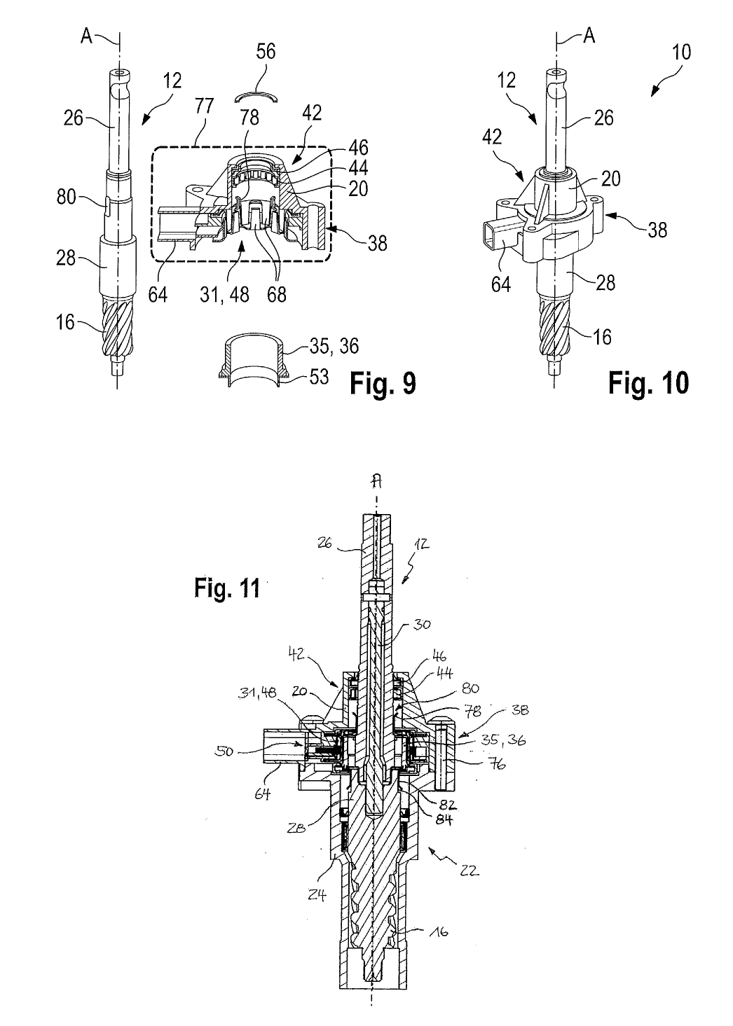

When assembling the motor vehicle steering assembly 10, the preassembled subassembly 77 according to FIG. 9 is pushed axially over the input shaft 26 and aligned in the circumferential direction such that the plug connection tongues 78 engage the flattened circumferential portion 80 and ensure a connection preventing relative rotation between the input shaft 26 and the magnetic structural unit 48.

The magnetic structural unit 48 is mounted so as to float in the housing upper part 20, for example. This allows the magnetic structural unit 48 to rotate relative to the housing upper part 20 and, if required, also allows a certain axial play of the magnetic structural unit 48 relative to the housing upper part 20.

After the preassembled subassembly 77 has been fitted on, it is axially retained and fixed in place by the snap ring 56.

Here, too, the final assembly step is to align the magnetic ring 36 in the circumferential direction relative to the magnetic structural unit 48 and to firmly connect it to, in particular weld it to, the output shaft 28.

FIGS. 11 to 14 show the motor vehicle steering assembly 10 according to a further embodiment.

The motor vehicle steering assembly 10 according to FIGS. 11 to 14 differs from the embodiment according to FIGS. 8 to 10 merely in that in this case the housing upper part 20 and the entire combined steering angle and steering torque sensor 18 inclusive of the magnetic ring 36 form a preassembled subassembly 81.

Therefore, the magnetic ring 36 is more difficult to access, so that it is not possible or only possible with increased effort to weld it to the output shaft 28.

By analogy with the first sensor element 31 of the magnetic structural unit 48, the second sensor element 35, formed as a magnetic ring 36, of the combined steering angle and steering torque sensor 18 correspondingly includes radially elastic plug connection tongues 82, which each engage a tangentially flattened circumferential portion 84 of the output shaft 28 to form an axial plug connection.

As a result, in this embodiment of the motor vehicle steering assembly 10, both the connection preventing relative rotation between the magnetic structural unit 48 and the input shaft 26 and the connection preventing relative rotation between the magnetic ring 36 and the output shaft 28 are in the form of axial plug connections.

In order to implement a stronger connection preventing relative rotation, it is also conceivable as an alternative to use the axial plug connections to produce a form-fitting engagement, for example by means of toothings engaging with each other. Variant embodiments of such plug connections are illustrated in FIGS. 15 to 22.

In this case, assembly of the motor vehicle steering assembly 10 is effected by simply fitting the preassembled subassembly 81 onto the steering shaft 12.

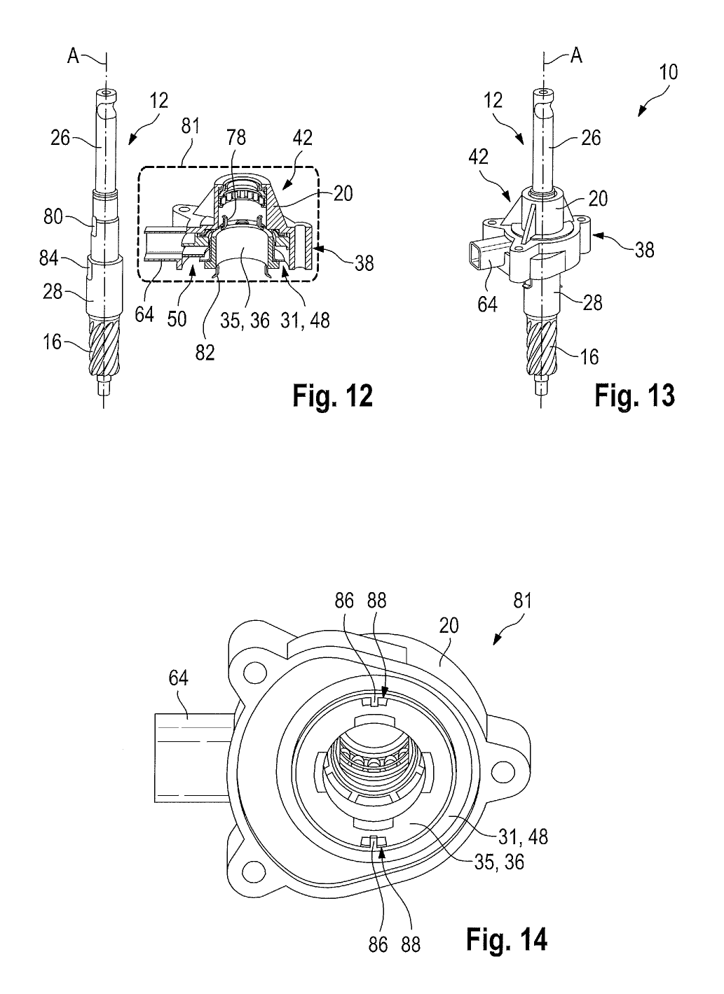

FIG. 14 shows a bottom view of the preassembled subassembly 81 according to FIG. 12 in the region of a rotary entrainment between the magnetic structural unit 48 and the magnetic ring 36. The magnetic structural unit 48 here encloses the magnetic ring 36 and has projections 86 directed radially inward. A radial outer surface of the magnetic ring 36 is provided with appropriate recesses 88 into which the projections 86 engage with a predefined circumferential play, so that the magnetic structural unit 48 and the magnetic ring 36 can be rotated relative to each other to a limited extent.

The integration of the magnetic ring 36 into the preassembled subassembly 81 in the form of a connection allowing limited rotation of a few angular degrees between the magnetic structural unit 48 and the magnetic ring 36 ensures an oriented and thus safe assembly.

FIGS. 15 to 22 show different variant embodiments of an axial plug connection for coupling the output shaft 28 to the second sensor element 35 so as to prevent relative rotation, the second sensor element 35 being formed as the magnetic ring 36.

For reasons related to illustration, FIGS. 15 to 21 merely show a form-fitting ring 90 which is firmly pre-mounted to the second sensor element 35. Specifically, the form-fitting ring 90 is a metal or plastic ring which is integrated in the second sensor element 35 or is welded or bonded thereto.

It is, of course, conceivable to use the illustrated axial plug connections also for coupling, in a manner preventing relative rotation, of the input shaft 26 to the first sensor element 31 formed as the magnetic structural unit 48. In this case, the form-fitting ring 90 would then be firmly connected to the magnetic structural unit 48, for example welded or bonded. If the form-fitting ring 90 is in the form of a metal ring and is fastened to a plastic component of the magnetic structural unit 48, it may be integrated into this plastic component, in particular by means of a plastic casing, the encasing in plastic being produced, for example, by an injection molding or injection blow molding process.

FIGS. 15, 16 and 17 show variant embodiments in each of which the output shaft 28 includes the pinion 16 at one axial end and an external toothing 92 at an opposite axial end. The form-fitting ring 90, firmly connected to the second sensor element 35, has a toothing 94 formed thereon, which engages with the external toothing 92 to produce a connection, preventing relative rotation, between the output shaft 28 and the second sensor element 35.

According to FIG. 15, the form-fitting ring 90 has an internal toothing that is complementary to the external toothing 92 of the output shaft 28 and has an identical tooth pitch. This results in an axially and radially particularly compact connection, preventing relative rotation, between the output shaft 28 and the second sensor element 35.

Alternatively, according to FIG. 16 it is also conceivable that the internal toothing of the form-fitting ring 90 has a larger tooth pitch than the external toothing 92 of the output shaft 28; this leads to a larger radial installation space required for the connection.

In order to reduce the radial installation space required, on the other hand, the form-fitting ring 90 according to FIG. 17 may also have axial extensions 96 spaced apart in the circumferential direction, at the free axial ends of which teeth of the toothing 94 are formed which engage in the external toothing 92. This, however, somewhat increases the installation space required in the axial direction.

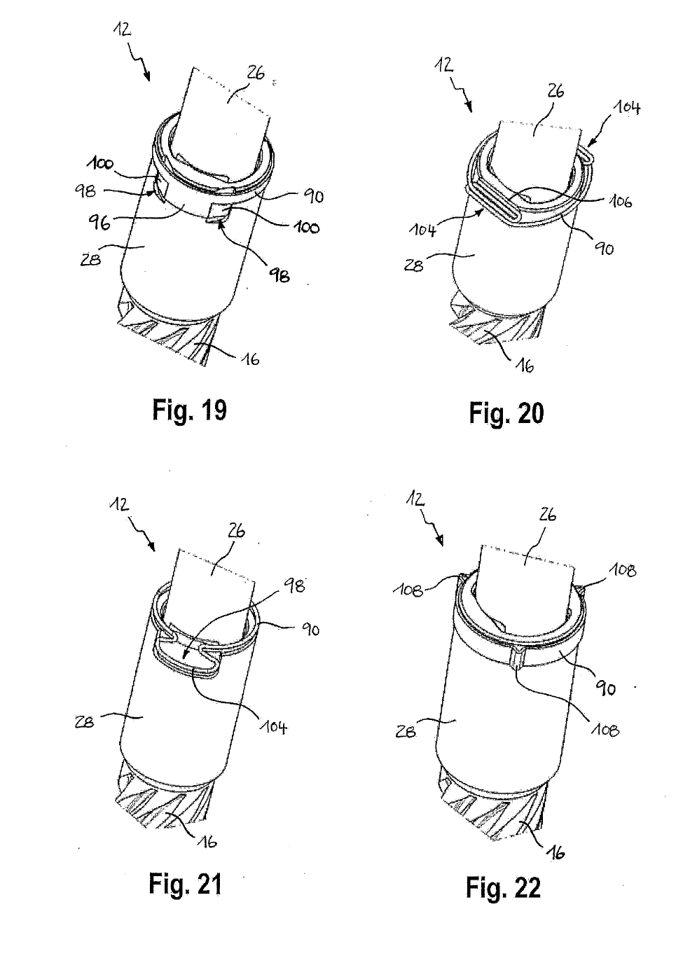

FIGS. 18 and 19 show variant embodiments in which the output shaft 28 has the pinion 16 at one respective axial end and grooves 98 at an opposite axial end, the grooves 98 extending in the axial direction. The form-fitting ring 90 firmly connected to the second sensor element 35 has spring clips 100 integrally formed with the form-fitting ring 90 and engaging in the grooves 98 to establish a connection preventing relative rotation between the output shaft 28 and the second sensor element 35.

According to FIG. 18, the spring clips 100 are in the form of axial spring arms which, starting from the circumferentially surrounding form-fitting ring 90, extend in the axial direction to a free end and engage with a precise fit into the grooves 98 of the output shaft 28 in the circumferential direction.

As an alternative, the circumferential form-fitting ring 90 may also include axial extensions 96 spaced apart in the circumferential direction, the spring clips 100 being formed at opposite ends of the extensions 96 in the circumferential direction and extending as tangential spring arms in the circumferential direction from one of the extensions 96 to a free end. The two spring arms formed integrally with an axial extension 96 engage with a precise fit in respectively associated grooves 98 of the output shaft 28 in the circumferential direction and in this way prevent a relative rotation between the second sensor element 35 and the output shaft 28.

FIGS. 20 and 21 show variant embodiments in which spring sections 104 that are spaced apart in the circumferential direction are formed or molded integrally with the form-fitting ring 90. The coupling to the output shaft 28, preventing relative rotation in the circumferential direction, takes place in the region of the spring sections 104, whereas between the spring sections 104 the form-fitting ring 90 is firmly connected to the second sensor element 35. In these variant embodiments the form-fitting ring 90 preferably is a wire ring, but may alternatively also be configured from a suitable plastic material.

According to FIG. 20, the round outer circumference of the output shaft 28 has the pinion 16 at one axial end and flattened portions 106 at an opposite axial end, which constitute flat tangential portions. The spring sections 104 of the form-fitting ring 90 extend toward the output shaft 28 in the radial direction and rest against the output shaft 28 in the region of the flattened portions 106 to provide for a connection, largely preventing relative rotation, between the second sensor element 35 and the output shaft 28.

According to FIG. 21, the output shaft 28 has the pinion 16 at one axial end and wide grooves 98 at an opposite axial end, the grooves 98 being spaced apart in the circumferential direction and extending in the axial direction. The spring sections 104 molded or formed integrally with the form-fitting ring 90 extend axially into the grooves 98 and engage in the grooves 98 in the circumferential direction with a precise fit in order to establish a connection, largely preventing relative rotation, between the output shaft 28 and the second sensor element 35.

Finally, FIG. 22 shows a variant embodiment in which the output shaft 28 has the pinion 16 at one axial end and the firmly preassembled form-fitting ring 90 at an opposite axial end. Depending on the configuration, the form-fitting ring 90 is more particularly welded or bonded to the output shaft 28.

In this case, the form-fitting ring 90 includes projections 108 distributed over its circumference and protruding radially outwards, which engage in complementarily formed recesses of the second sensor element 35 with a precise fit to form a connection preventing relative rotation between the output shaft 28 and the second sensor element 35.

All of the coupling variants according to FIGS. 15 to 22, which prevent relative rotation and are form-fitting, are configured as axial plug connections in an advantageous manner, so that the motor vehicle steering assembly 10 can be assembled with little mounting effort.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A motor vehicle steering assembly, comprising
a steering shaft which extends from a vehicle steering wheel to a pinion and is rotatable about a steering axis,
a combined steering angle and steering torque sensor which includes sensor elements connected to the steering shaft for joint rotation therewith, and
a housing upper part of a multipart steering gear housing which closes, on a steering wheel side, a housing lower part for receiving the pinion, the housing lower part being open in an axial direction towards the vehicle steering wheel,
the combined steering angle and steering torque sensor being received in the housing upper part, and
the steering shaft extending through the housing upper part,
wherein the sensor elements connected to the steering shaft for joint rotation therewith are directly adjacent to the housing upper part.

2. The motor vehicle steering assembly according to claim 1, wherein the steering shaft comprises an input shaft connected to the vehicle steering wheel, an output shaft connected to the pinion, and a torsion element which couples the input shaft and the output shaft in a circumferential direction.

3. The motor vehicle steering assembly according to claim 1, wherein the combined steering angle and steering torque sensor comprises a first sensor element having a connection to the input shaft for joint rotation therewith, and a second sensor element having a connection to the output shaft for joint rotation therewith, at least one of the connections for joint rotation being formed as an axial plug connection.

4. The motor vehicle steering assembly according to claim 3, wherein the first sensor element or the input shaft includes an integrated or firmly preassembled form-fitting ring for forming the connection for joint rotation.

5. The motor vehicle steering assembly according to claim 3, wherein the second sensor element or the output shaft includes an integrated or firmly preassembled form-fitting ring for forming the connection for joint rotation.

6. The motor vehicle steering assembly according to claim 3, wherein at least one of the first and second sensor elements includes radially elastic plug connection tongues which each engage a tangentially flattened circumferential portion of the input shaft and/or of the output shaft to form the axial plug connection.

7. The motor vehicle steering assembly according to claim 3, wherein the housing upper part comprises a flange portion which surrounds the first and second sensor elements connected to the steering shaft for joint rotation therewith and is connected to the housing lower part.

8. The motor vehicle steering assembly according to claim 7, wherein the housing upper part comprises a bearing portion which includes a radial bearing for rotatably mounting the steering shaft.

9. The motor vehicle steering assembly according to claim 8, wherein a sealing element for sealing between the housing upper part and the steering shaft is arranged in the bearing portion.

10. The motor vehicle steering assembly according to claim 7, wherein the flange portion and the bearing portion constitute separate components of the housing upper part.

11. The motor vehicle steering assembly according to claim 10, wherein the flange portion of the housing upper part surrounds the combined steering angle and steering torque sensor and is arranged axially between the bearing portion of the housing upper part and the housing lower part.

12. The motor vehicle steering assembly according to claim 10, wherein the combined steering angle and steering torque sensor comprises a magnetic ring, a magnetic structural unit that can be rotated relative to the magnetic ring, and an electric sensor unit, the flange portion, the magnetic structural unit and the electric sensor unit constituting a preassembled subassembly.

13. The motor vehicle steering assembly according to claim 8, wherein the flange portion and the bearing portion of the housing upper part are formed in one piece.

14. The motor vehicle steering assembly according to claim 1, wherein the combined steering angle and steering torque sensor comprises a magnetic ring, a magnetic structural unit that can be rotated relative to the magnetic ring (36), and an electric sensor unit, the housing upper part, the magnetic structural unit and the electric sensor unit constituting a preassembled subassembly.

15. The motor vehicle steering assembly according to claim 1, wherein the housing upper part and the combined steering angle and steering torque sensor constitute a preassembled subassembly.

16. The motor vehicle steering assembly according to claim 1, wherein the combined steering angle and steering torque sensor comprises a magnetic ring, a magnetic structural unit, and an electric sensor unit, the magnetic structural unit including a gear rim arranged coaxially with the steering shaft and firmly connected to the steering shaft, and the electric sensor unit including at least one elastically supported gearwheel which is in meshing engagement with the gear rim.
